(19) United States
(12) Patent Application Publication
(10) Pub. No.: US 2026/0001539 A1
(43) Pub. Date: Jan. 1, 2026

(54) SYSTEM AND METHOD FOR VEHICLE WINCH OPERATION

(71) Applicant: SCOUT MOTORS INC., Tysons, VA (US)

(72) Inventors: Bryan Mutchler, Lake Orion, MI (US); Markus Ulrich, West Bloomfield Township, MI (US)

(21) Appl. No.: 18/758,449

(22) Filed: Jun. 28, 2024

(51) Int. Cl. B60W 30/14

(52) U.S. Cl. CPC B60W 30/143; B60W 2510/08; B60W 2520/28; B60W 2520/30; B60W 2530/20; B60W 2554/20; B60W 2554/804; B60W 2720/28

(57) ABSTRACT

Provided herein is an apparatus, system, and method for reducing a power drawn by a winch as it pulls a vehicle. Methods can include: receiving an indication to operate a vehicle in a winch mode; detecting movement of the vehicle caused by a force from a winch of the vehicle; determining of a speed of movement of the vehicle caused by the force from the winch pulling the vehicle; and providing for control of at least one driven wheel of the vehicle to rotate at a speed corresponding to the speed of movement of the vehicle within a predefined degree of similarity. According to some embodiments the speed of movement of the vehicle is determined based at least in part on a speed of rotation of at least one wheel not being driven by the powertrain of the vehicle.

### BACKGROUND

Vehicles, and particularly vehicles designed for off-road use, are often equipped with powered winches. A powered winch can be used for a variety of purposes on a vehicle including, primarily, the extraction of stuck vehicles. “Extracting” a stuck vehicle can generally refer to self-recovery (e.g., in which a vehicle extracts itself from a stuck position) and/or assisted recovery (e.g., in which a second vehicle helps to extract a first vehicle from a stuck position). For example, vehicle self-recovery can involve extricating a vehicle using the vehicle's equipped winch from a location or position from which the vehicle is incapable of advancing itself out of using only the motive force of the wheels and tires. A winch can be employed for vehicle self-recovery by securing a cable of the winch to a stationary object and drawing the cable into the winch to pull the vehicle out of the immobile position. Similarly, a winch on a first vehicle can be used to help extract a second vehicle from a stuck position, in which case the winch on the first vehicle is attached to the second vehicle instead of or in addition to being attached to a stationary object.

### SUMMARY

A system and method are therefore provided for operation of a vehicle winch, and more particularly, for controlling a vehicle to provide motive power that reduces a power draw of the vehicle winch and enhances the ability of the vehicle to self-recover. An embodiment provided herein includes an apparatus including at least one processor and at least one non-transitory memory including computer program code instructions, the computer program code instructions configured to, when executed by the at least one processor, cause the apparatus to: receive an indication to operate a vehicle in a winch mode; detect movement of the vehicle caused by a force from a winch pulling the vehicle; determine a speed of movement of the vehicle caused by the force from the winch pulling the vehicle; and provide for control of at least one driven wheel of the vehicle to rotate at a speed corresponding to the speed of movement of the vehicle within a predefined degree of similarity.

According to some embodiments, the speed of movement of the vehicle is determined based at least in part on a speed of rotation of at least one wheel not being driven by a powertrain of the vehicle. According to certain embodiments, the speed of movement of the vehicle is determined based at least in part on a speed of rotation of at least one wheel and an outer diameter of a tire associated with the at least one wheel. The apparatus of some embodiments is further caused to determine a tire pressure of the tire associated with the at least one wheel; and calculate an effective outer diameter of the tire associated with the at least one wheel based on a size of the tire associated with the at least one wheel and the tire pressure of the tire associated with the at least one wheel.

According to certain embodiments, the speed of movement of the vehicle is determined based at least in part on an average speed of rotation of at least two wheels of the vehicle. According to some embodiments, causing the apparatus to determine the speed of movement of the vehicle caused by the force from the winch pulling the vehicle includes causing the apparatus to determine the speed of movement of the vehicle based at least in part on detecting movement of the vehicle relative to a stationary object proximate the vehicle. Causing the apparatus of some embodiments to determine the speed of movement of the vehicle based, at least in part on detecting movement of the vehicle relative to a stationary object proximate the vehicle includes causing the apparatus to determine the speed of movement of the vehicle using a distance-measuring sensor.

According to some embodiments, causing the apparatus to provide for control of at least one driven wheel of the vehicle to rotate at a speed corresponding to the speed of movement of the vehicle within a predefined degree of similarity includes causing the apparatus to determine one or more drive wheels that have traction with terrain over which the vehicle is traveling; and provide power to the one or more drive wheels that have traction with the terrain. Causing the apparatus of some embodiments to determine one or more drive wheels that have traction with terrain over which the vehicle is traveling includes causing the apparatus to determine a torque force at the one or more drive wheels; and determine the one or more drive wheels that have traction with the terrain based on the torque force of the one or more drive wheels satisfying a predetermined threshold.

According to certain embodiments, causing the apparatus to determine the one or more drive wheels that have traction with terrain over which the vehicle is traveling includes causing the apparatus to: determine a power draw of at least one electric motor associated with at least one of the one or more drive wheels; and determine the one or more drive wheels that have traction with the terrain based on the power draw at the at least one electric motor associated with at least one of the one or more drive wheels satisfying a predetermined threshold.

Embodiments provided herein include a method including: receiving an indication to operate a vehicle in a winch mode; detecting movement of the vehicle caused by a force from a winch of the vehicle; determining of a speed of movement of the vehicle caused by the force from the winch pulling the vehicle; and providing for control of at least one driven wheel of the vehicle to rotate at a speed corresponding to the speed of movement of the vehicle within a predefined degree of similarity. According to some embodiments the speed of movement of the vehicle is determined based at least in part on a speed of rotation of at least one wheel not being driven by a powertrain of the vehicle.

According to certain embodiments the speed of movement of the vehicle is determined based at least in part on a speed of rotation of at least one wheel and an outer diameter of a tire associated with the at least one wheel. The method of some embodiments further includes determining a tire pressure of the tire associated with the at least one wheel and calculating an effective outer diameter of the tire associated with the at least one wheel based on a size of the tire associated with the at least one wheel and the tire pressure of the tire associated with the at least one wheel. According to some embodiments the speed of movement of the vehicle is determined based at least in part on an average speed of rotation of at least two wheels of the vehicle.

According to certain embodiments determining the speed of movement of the vehicle caused by the force from the winch pulling the vehicle includes determining the speed of movement of the vehicle based at least in part on detecting movement of the vehicle relative to a stationary object proximate the vehicle. According to some embodiments providing for control of at least one driven wheel of the vehicle to rotate at a speed corresponding to the speed of movement of the vehicle within a predefined degree of similarity includes determining one or more drive wheels that have traction with terrain over which the vehicle is traveling and providing power to the one or more drive wheels that have traction with the terrain. Determining one or more drive wheels that have traction with terrain over which the vehicle is traveling includes, in some embodiments, determining a torque force at the one or more drive wheels and determining the one or more drive wheels that have traction with the terrain based on the torque force of the one or more drive wheels satisfying a predetermined threshold.

According to certain embodiments, determining one or more drive wheels that have traction with terrain over which the vehicle is traveling includes determining a power draw at an electric motor associated with each of the one or more drive wheels; and determining the one or more drive wheels that have traction with the terrain based on the power draw at the electric motor associated with each of the one or more drive wheels satisfying a predetermined threshold.

Embodiments provided herein include a vehicle including a body, a winch, a powertrain; and a controller configured to receive an indication to operate the vehicle in a winch mode, detect movement of the vehicle caused by the winch pulling the vehicle, determine a speed of movement of the vehicle caused by the winch pulling the vehicle, and provide for control of at least one driven wheel of the vehicle to rotate at a speed corresponding to the speed of movement of the vehicle within a predefined degree of similarity.

### DESCRIPTION OF THE DRAWINGS

Having thus described certain example embodiments of the present disclosure in general terms, reference will hereinafter be made to the accompanying drawings which are not necessarily drawn to scale, and wherein:

FIG. 1 illustrates a block diagram of a controller for a vehicle or subsystem thereof to aid in reducing the power draw required by a winch according to an example embodiment of the present disclosure;

FIG. 2 illustrates a top-view of a vehicle including a winch as secured to an object according to an example embodiment of the present disclosure;

FIG. 3 illustrates a top-view of a vehicle including a winch as secured to another object according to an example embodiment of the present disclosure; and

FIG. 4 illustrates a flow chart of a process for reducing the power draw required by a winch according to an example embodiment of the present disclosure.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

Embodiments described herein generally relate to operation of a vehicle winch, and more particularly, to controlling a vehicle to provide motive power that reduces a power draw of the vehicle winch. Vehicle winches are generally powered by a low voltage system of the vehicle that provides power to a motor of the winch to wind a cable about a drum. Such a winch uses an electric motor providing sufficient torque to move a vehicle from a stuck position. The power draw of the winch is dependent upon the load placed on the motor and a duration of the pull. The mere spooling of an unloaded cable of a typical 9,000 pound winch can draw 60-70 amps, while at max load pulling 9,000 pounds, the same winch can draw 450 amps. This power draw is significant and taxing on the low voltage electrical system of a vehicle.

It is desirable to reduce the electrical load of a winch to mitigate power consumption and reduce the low voltage electrical draw. Further, excessive current draw on a battery, such as a lead acid battery found in many low-voltage vehicle applications, can damage the battery, and reduce battery life and damage electrical system components. Given that winches can draw a substantial current, the present disclosure describes embodiments that can reduce the current draw thereby improving the functionality and efficiency of the low voltage system of a vehicle.

A vehicle winch generally includes a housing, within which is a spool around which a cable having a high tensile strength is wound. The spool may be driven by a variety of drive configurations, such as purely electric drives or hydraulic/electric drives. In a purely electrically driven winch, an electric motor is coupled to the spool, possibly through a gear box or gear reducer. This configuration is relatively simple. Hydraulic winches employ an electric motor to function as a hydraulic pump, where the hydraulic pressure generated by the hydraulic pump is used to drive the spool. In either type, the power from the vehicle is provided in the form of electricity.

The power consumption of a winch, regardless of drive type, is based on the amount of load exerted by the winch to wind the cable around the spool. In the case of vehicle self-recovery, for example, this can mean that the gross vehicular weight of a vehicle is the weight pulled by the winch, compounded by both an angle at which the cable is pulling and the position from which the vehicle being extracted is being drawn. For example, pulling a vehicle up a grade generates more load on the winch than pulling a vehicle along a flat surface, all else being equal. Similarly, pulling a vehicle through sand provides more resistance and greater load than pulling a vehicle across a low-friction surface such as snow or ice.

Embodiments described herein provide a method, apparatus, and system for reducing the power consumption of a winch by providing some degree of assistance to the winch as it pulls a vehicle along. Embodiments described herein may be used by the operator of a vehicle and accessed through a user interface of the vehicle. The user interface may include a user interface display through which the user can enter a “winch mode,” as described further below, or otherwise employ various techniques described herein. A user interface display may include, for example, an infotainment screen, a digital gauge cluster screen, or the like. According to some embodiments, the user interface may not require a display and may employ tactile buttons, switches, vehicle pedals or dials.

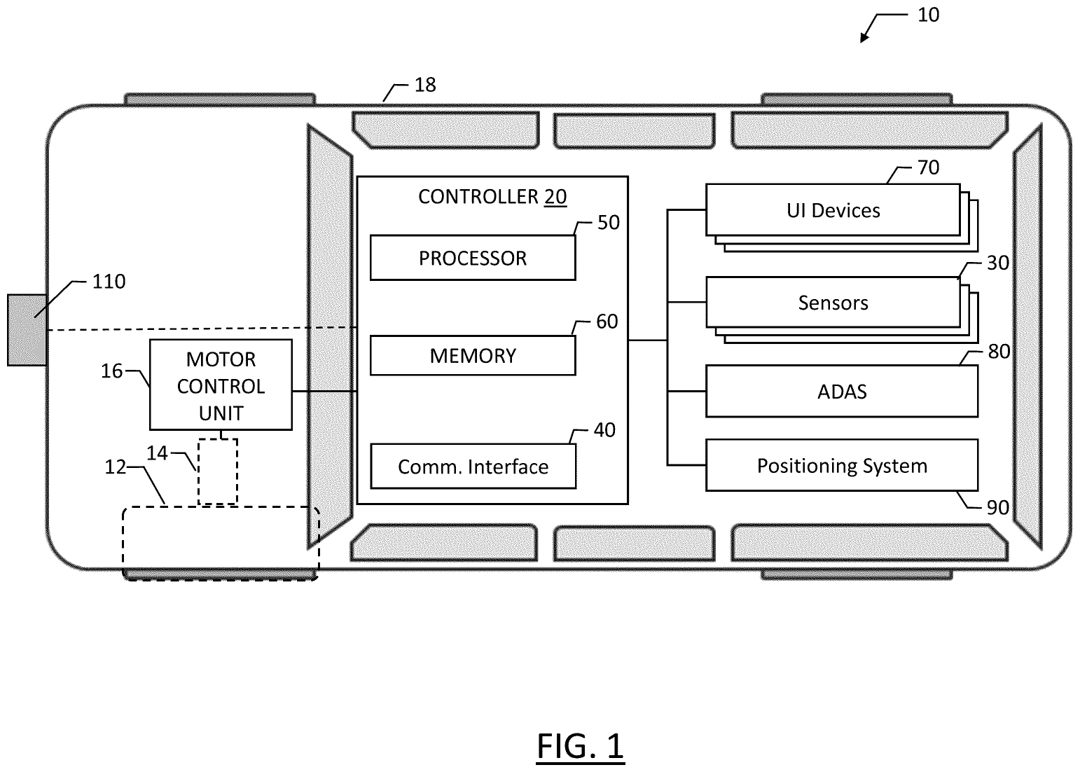

A user interface of embodiments described herein can be controlled, for example, using a controller where the controller may be embodied as a vehicle controller or a sub-unit controller of the vehicle, such as an infotainment system controller, traction system controller, etc. FIG. 1 is a schematic diagram of an example embodiment of a vehicle 10 and a controller 20. The vehicle 10 is depicted with body 18 which generally encompasses the structure of the vehicle. The controller 20 of some embodiments is integrated into the vehicle 10 and connected to different elements described herein, such as through a wiring harness. The illustrated controller 20 can be embodied as any controller of the vehicle 10 for controlling any features of the vehicle 10, with the depicted features of the illustrated embodiment being optional depending upon the application. For example, as mentioned above, the controller 20 can be embodied as an infotainment system controller; however, the present disclosure is not intended to be limiting in this regard. In other embodiments, the controller 20 could be a stand-alone controller or could be embodied via another vehicle controller, such as a vehicle control unit (VCU), an Advanced Driver Assistance System (ADAS) controller, or the like.

The controller 20 of FIG. 1 can be configured to perform any of the operations described herein. Controller 20 is an example embodiment that may be embodied by or associated with any of a variety of computing devices that include or are otherwise associated with a vehicle. The controller 20 can be in communication with any systems, sensors, or other controllers of the vehicle 10, such as via a communications interface (e.g., a CAN bus). According to some embodiments, the controller 20 can include a computing device that provides instructions or commands to a vehicle control module or other vehicle controller, where the controller is a device in communication with various vehicle systems and control architectures. In this manner, some embodiments can be implemented on purely in-vehicle systems, through mobile devices commanding in-vehicle systems, or a combination thereof. One such example is a winch operated by a remote device, such as a remote controller, smart phone, or the like, which may be used in embodiments described herein.

Optionally, the controller 20 may be embodied by or associated with a plurality of computing devices that are in communication with or otherwise networked with one another such that the various functions performed by the apparatus may be divided between the plurality of computing devices that operate in collaboration with one another.

The controller 20 may include, be associated with, or may otherwise be in communication with a communication interface 40, a processor 50, and a memory 60

[symbol]

The controller 20 may be in communication with one or more user interface devices 70, such as one or more displays that may include touch screen displays. In some embodiments, the processor 50 (and/or co-processors or any other processing circuitry assisting or otherwise associated with the processor) may be in communication with the memory 60 via a bus for passing information among components of the controller. The memory 60 may be non-transitory and may include, for example, one or more volatile and/or non-volatile memories. In other words, for example, the memory may be an electronic storage device (for example, a computer readable storage medium) comprising gates configured to store data (for example, bits) that may be retrievable by a machine (for example, a computing device like the processor). The memory 60 may be configured to store information, data, content, applications, instructions, or the like for enabling the apparatus to carry out various functions in accordance with an example embodiment of the present disclosure. For example, the memory 60 could be configured to buffer input data for processing by the processor. Additionally or alternatively, the memory 60 could be configured to store instructions for execution by the processor.

The processor 50 may be embodied in a number of different ways. For example, the processor 50 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 50 may include one or more processing cores configured to perform independently. A multi-core processor may enable multiprocessing within a single physical package. Additionally or alternatively, the processor 50 may include multiple processors configured in tandem via the bus to enable independent execution of instructions, pipelining and/or multithreading.

In an example embodiment, the processor 50 may be configured to execute instructions stored in the memory 60 or otherwise accessible to the processor. Alternatively or additionally, the processor 50 may be configured to execute hard coded functionality. As such, whether configured by hardware or software methods, or by a combination thereof, the processor 50 may represent an entity (for example, physically embodied in circuitry) capable of performing operations according to an embodiment of the present disclosure while configured accordingly. Thus, for example, when the processor 50 is embodied as an ASIC, FPGA or the like, the processor 50 may be specifically configured hardware for conducting the operations described herein.

Alternatively, as another example, when the processor 50 is embodied as an executor of software instructions, the instructions may specifically configure the processor 50 to perform the algorithms and/or operations described herein when the instructions are executed. However, in some cases, the processor 50 may be a processor of a specific device (for example, the computing device) configured to employ an embodiment of the present disclosure by further configuration of the processor by instructions for performing the algorithms and/or operations described herein.

As noted above, the controller 20 of an example embodiment may also include or otherwise be in communication with one or more user interface devices 70. The user interface devices 70 can include any feature of the vehicle 10 that a user interacts with including features such as climate control, infotainment interface, gauge cluster, etc. In this regard, the user interface devices 70 may include or otherwise be in communication with one or more displays, such as an infotainment system display, a gauge cluster, an entertainment system display (e.g., for rear seat passengers) or the like. The user interface devices 70 may optionally include one or more speakers, physical buttons, analog display (e.g., speedometer, fuel gauge, etc.) and/or other input/output mechanisms. The user interface devices 70 may be incorporated into the vehicle 10, such as a dedicated navigation system display/audio system or a device that can attach or associate with the vehicle via communication link. In an example embodiment, the processor 50 may include user interface circuitry configured to control at least some functions of one or more input/output mechanisms. The processor 50 and/or user interface circuitry comprising the processor 50 may be configured to control one or more functions of one or more input/output mechanisms through computer program instructions (for example, software and/or firmware) stored on a memory accessible to the processor (for example, memory 60, and/or the like).

As shown, the vehicle 10 may be equipped with any number of sensors 30. As described herein, a “sensor” refers to any sensing device which can be used to determine properties of the environment of the vehicle 10, properties of the vehicle itself, forces applied from/to the vehicle, or the like. Accordingly, the sensors 30 can include, but are not limited to, image sensors, LiDAR sensors, wheel speed sensors, and/or tire pressure sensors, among various other types of sensors. For example, the sensor 30 can determine a speed of movement of the vehicle in some embodiments. As another example, the sensor can determine a current tire pressure of a tire of the vehicle.

It should be appreciated that the vehicle 10 may include a number of other sensors which may not be explicitly illustrated. For example, the vehicle 10 may include one or more of an accelerometer, a gyroscope, and a speed sensor (e.g., wheel speed sensors) to sense information regarding the movement, positioning, or orientation of the vehicle 10, e.g., for use in navigation assistance. In one such example, the vehicle 10 (or the controller 20 itself) could include an inertial measurement unit (IMU) that functions as an accelerometer and a gyroscope. The vehicle 10 may also include a light sensor, various image sensors (e.g., cameras), and more. As described in greater detail below, for example, the vehicle 10 may include various sensors and/or transceivers used for detecting a position, speed, etc. (e.g., for navigation) and/or for implementing various driving aids (e.g., parking sensors, radar for automatic cruise control and/or automated braking, cameras for lane center and object avoidance, etc.).

The controller 20 of an example embodiment may also optionally include a communication interface 40 that may be any means such as a device or circuitry embodied in either hardware or a combination of hardware and software that is configured to receive and/or transmit data from/to other electronic devices in communication with the controller 20. Additionally or alternatively, the communication interface 40 may be configured to communicate over any wired or wireless communication protocols. In some environments, the communication interface 40 may alternatively or additionally support vehicle to vehicle or vehicle to infrastructure wireless links.

The controller 20 of an example embodiment can be embodied by or otherwise in communication with various other vehicle controllers which can be separate or in a single module; however, it will be appreciated that these controllers function in concert to enable various aspects of vehicle functionality. As such, the controller 20 can be interpreted as a general controller performing each of these functions to enable vehicle functionality accordingly.

As shown, the vehicle 10 can further include an advanced driver assistance system (ADAS) 80 configured to perform various driver-assistance functions of a vehicle, including control features that may be part of autonomous control of a vehicle, such as adaptive headlight aiming, adaptive cruise control, lane departure warning and control, curve warning, and hazard warning, among others.

The ADAS 80 may be used to provide various functionality of a vehicle and may be implemented to improve the comfort, efficiency, safety, and overall satisfaction of driving. Some of these advanced driver assistance systems use a variety of sensors in the vehicle to determine the current state of the vehicle and the current state of the roadway ahead of the vehicle. These sensors may include radar, infrared, ultrasonic, and vision-oriented sensors such as image sensors and light distancing and ranging (LiDAR) sensors. According to some embodiments, and which may be particularly useful for off-road capable vehicle, the sensors of an ADAS 80 can include, for example, various cameras such as cameras directed to the wheels and terrain proximate the wheels to help guide a driver/occupant with respect to how to navigate challenging off-road terrain. These cameras can be in the vehicle and/or around the exterior of the vehicle, such as in a wheel arch, fender flare, wing mirror, bumper, brush guard, etc.

According to embodiments described below, the ADAS 80 or other controller may be employed to determine a speed of movement of the vehicle as it is pulled by the winch and/or provide for motive force to drive at least one drive wheel at a speed corresponding with a speed that the vehicle is being pulled by the winch.

The vehicle 10 can optionally include a positioning system 90 which may be in communication with controller 20 as shown in FIG. 1. The positioning system can include any type of Global Navigation Satellite Systems (GNSS) such as the Global Positioning System (GPS), BeiDou Navigation Satellite System (BDS) positioning system, Galileo positioning system, or any other standardized positioning system. The positioning system 90 can optionally include systems that are not satellite-based, but use other methods of localization, such as wireless access point triangulation or the like. The positioning system 90 can be used in conjunction with the ADAS 80 or user interface devices 70 such as a navigation system, for example. The positioning system 90, if employing a highly accurate localization technique, may be able to determine speed of movement of the vehicle and/or may otherwise be used to supplement other speed of movement determinations (e.g., using wheel speed sensors). While vehicle speed can be discerned from GNSS, such vehicle speed is more accurate at relatively higher speeds (e.g., more than 20 miles per hour), while GNSS are not generally effective at very low speeds (e.g., less than 5 miles per hour), such that the positioning system 90 may be employed for low-speed determination only in certain circumstances.

FIG. 1 also illustrates a winch 110 of the vehicle 10. This winch 110 can be a stand-alone unit that has no communication with the vehicle in some embodiments. In other embodiments the winch 110 can include a communications interface to communicate with the controller 20, for example. While a stand-alone winch can be controlled by a wired or wireless control to operate the winch, a “smart winch” can receive and provide various signals to and from a controller 20 of a vehicle 10. Such signals can include control of the winch operation through, for example, a user interface device 70. Optionally, a smart winch could provide an amount of power or current drawn by the winch 110 during operation. A smart winch can optionally provide a speed with which the winch cable is being drawn into the winch 110 in some embodiments. Embodiments of the present disclosure can be employed with a conventional stand-alone winch, a smart winch, or any winch 110 connected to a vehicle 10.

Also shown in FIG. 1 is one of the wheels 12, which in the illustrated embodiment is a driven wheel powered by motor 14. The motor 14 may be controlled, for example, by motor control unit 16, which may be part of or in communication with a powertrain control unit, which may be embodied by controller 20. The motor 14 may be one of the motors powering drive wheels of the vehicle 10, where each driven wheel may have its own motor or receive power via a gearbox (e.g., a differential) driven by a motor. The one or more motors and corresponding motor control units together form the powertrain of an example vehicle 10.

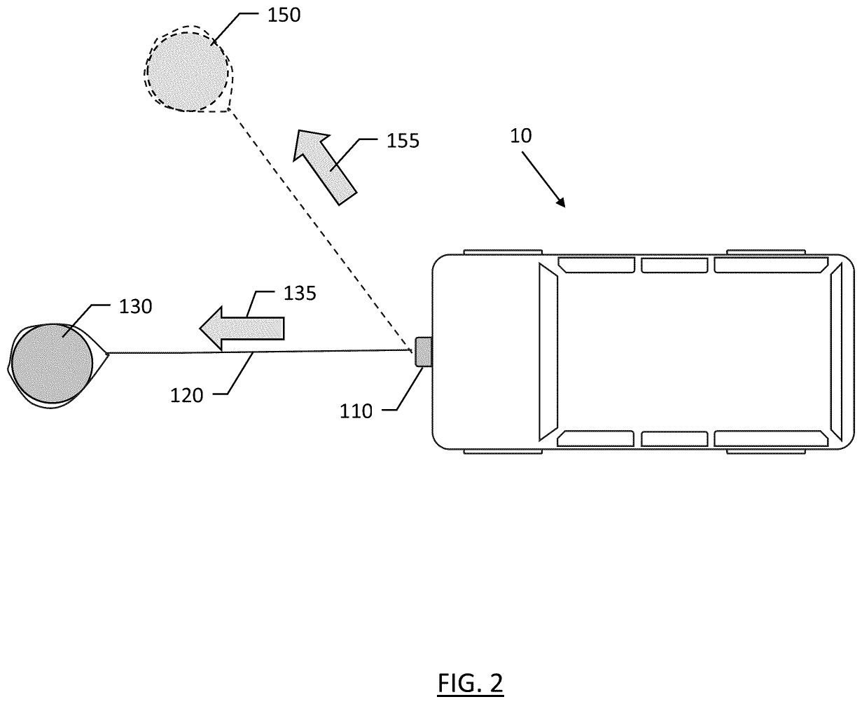

In many cases, there are only limited variables that can be controlled by the winch operator, e.g., during vehicle extraction or self-recovery. One such variable is the angle at which a winch cable is tensioned relative to a direction the vehicle is to be moved. FIG. 2 illustrates an example embodiment of a vehicle 10 with a winch 110 and winch cable 120. As shown, when the winch cable 120 is attached to an object 130, which may be a tree, boulder, or some other object of sufficient stability, the vehicle 10 is pulled in the direction of arrow 135 along which the vehicle 10 and wheels of the vehicle 10 are facing. If the winch cable 120 is instead attached to an object 150, the load on the winch 110 is increased (assuming all other variables are equal) as the vehicle 10 is being pulled at an angle along arrow 155 relative to a direction the vehicle 10 and wheels are positioned.

Some embodiments described herein reduce the load on a winch by providing assistance to the winch to reduce the work performed by the winch. Referring to the illustration of FIG. 2, if vehicle 10 is being pulled in the direction of arrow 135, the vehicle of embodiments described herein provide motive force in the direction of arrow 135 as it is able to do so. This reduces the pulling load on the winch 110 by providing a “push” to the vehicle 10. The vehicle 10 requiring extraction is inherently unable to advance under only its own power through the wheels in the direction of arrow 135, such that the pulling of the winch 110 in combination with the turning of the driven wheels in the direction of arrow 135 can reduce the overall load on the winch to extract the vehicle from the stuck position.

While the embodiment of FIG. 2 is illustrated with a front-mounted winch 110 on the vehicle 10, embodiments can employ a rear-mounted winch on the vehicle while employing the same control mechanisms described herein. Driven vehicle wheels are capable of driving forward and in reverse such that employing the system and method described herein to advance a vehicle rearward can be done using the same techniques without deviating from the scope of the disclosure.

Embodiments described herein provide an ability to coordinate a speed of the wheels of the vehicle as driven by a powertrain of the vehicle (the “driven wheels”) to a speed with which the winch is pulling a vehicle otherwise described herein as the speed of movement of the vehicle. To accomplish this, the vehicle of embodiments described herein determines a speed of vehicle movement which is caused by a force other than the powertrain of the vehicle. According to some embodiments, the force is a force induced by the winch pulling the vehicle. The powertrain is then employed to cause at least one driven wheel of the vehicle to be driven at the same speed as, or a speed within a predefined degree of similarity to, the speed at which the winch is pulling the vehicle. This predefined degree of similarity may be, for example, within one or two miles per hour.

When a vehicle is being moved by forces other than the powertrain (e.g., a winch), controlling speed of the driven wheels of a vehicle via a powertrain (such as via motor control unit 16 or a powertrain controller) to match the speed of movement of the vehicle is challenging, and unlikely to be accomplished within a predefined degree of similarity using manual input, such as using an accelerator pedal of the vehicle. This is due to a variety of factors including varying amounts of pedal input based on differing terrains, obstacles, or the like. As such, embodiments described herein provide a system and method to control a vehicle to provide motive power via the driven wheels to reduce a force required to move the vehicle by a winch and hence the power draw of the winch by controlling a speed of driven wheels of the vehicle at a speed that corresponds with the speed of movement of the vehicle.

The powertrain of a vehicle, as described herein, includes a drive system, which enables power to be provided to the driven wheels of the vehicle. As described further below, the powertrain can be that of (i) a conventional internal combustion engine (including gears, driveshafts, etc.), (ii) a hybrid-electric vehicle employing both an internal combustion engine and electric motors, or (iii) a purely electric vehicle employing electric motors for the powertrain.

To determine the speed of movement of the vehicle, embodiments described herein determine a rate at which the vehicle is being moved by the winch. There are several ways that this determination of the speed of movement of the vehicle may be made. For example, the speed of movement can be determined using a speed of a wheel, and particularly the speed of a non-driven wheel. The rotational speed of a non-driven wheel, when a vehicle is being pulled in a direction parallel to the wheel, will provide a robust estimate of actual speed of movement of the vehicle. The speed of a wheel can be determined in a number of different ways. For example, the speed of rotation of a wheel can be determined using a wheel speed sensor, examples of which may be incorporated into braking systems for the wheel and often used with antilock braking systems to avoid wheel lock upon braking. This may involve a toothed wheel where the teeth are counted to determine revolutions per minute. In the case of an all-wheel-drive vehicle, where each wheel is a driven wheel, particularly in the case of an electric vehicle with electric motors (e.g., motor 14) controlling rotation of each wheel (e.g., using motor control unit 16), one or more driven wheels could be deactivated, or cease to be driven by the motor 14 at least temporarily by the motor control unit 16 to use that wheel to ascertain speed of movement of the vehicle. This could be performed periodically so as to retain the advantages of the all-wheel-drive capabilities. Optionally, the driven wheel deactivated to obtain speed of movement of the vehicle could be systematically changed so as to not deactivate the same drive wheel each time.

To determine speed of movement of a vehicle based on rotational speed of a wheel, the outer diameter of the tire attached to the wheel needs to be known. Generally, the outer diameter of a tire sold with a vehicle is specifically known with a high degree of accuracy, such that speed of movement can be identified from a properly inflated tire of a known size rotating at a known speed. However, in scenarios in which a driver is operating “off road”, it is not uncommon to “air down” tires or reduce air pressure in tires to increase surface contact patches of the tires with the terrain. In such a case, the effective rolling diameter of the wheel/tire combination changes. Some embodiments described herein can determine accurate speed of movement of a vehicle through use of a combination of wheel speed, known tire size, and measured tire pressure. The degree of squish of a tire can be closely estimated using the tire size and tire pressure, such that an effective rolling diameter can be calculated to determine an accurate measure of speed of movement of a vehicle.

While a single wheel, and particularly one that is not being driven, can be used to determine speed of movement of a vehicle, a combination of the speeds of two or more wheels can be used to determine speed of movement of the vehicle. For example, the average speed of a pair, three, or all wheels can be used to determine a speed of movement of the vehicle.

The speed of movement of a vehicle can optionally be determined using other available sensors. For example, vehicles employing a high level of autonomous control features generally employ cameras and surface detecting sensors such as LiDAR (Light Distancing and Ranging). A vehicle that is being pulled via a winch is generally moving at a relatively low speed. A LiDAR sensor at the front or rear of a vehicle can identify static features in the environment and determine a change in distance of the feature from the vehicle over time from which a speed of movement of a vehicle can be calculated.

Global Positioning Systems (GPS) can be used to estimate speeds; however, the accuracy of GPS renders very low speeds, such as those at which a vehicle moves when being pulled by a winch, relatively inaccurate. However, other over-the-air positioning mechanisms can be employed, including those that can be used together with GPS to obtain more accurate speed information. Further, triangulation of location using terrestrial based signals, such as cellular signals, can be used to better estimate speed of movement in some circumstances.

Embodiments described herein establish speed of movement of a vehicle when imparted by forces other than the driven wheels, such as when a vehicle is being pulled by a winch. In some embodiments, a winch may be configured to report a speed at which a cable is pulled into the winch, and a speed of movement of the vehicle can be ascertained from that information.

Based on the speed of movement of the vehicle being pulled, the driven wheels of a vehicle may then operate to attempt to drive the vehicle at a corresponding speed, or a speed within a predefined degree of the measured speed. The wheel or wheels driven in an effort to “push” the vehicle aid the pulling action of the winch, and thereby reduce the power consumption of the winch. The wheel or wheels providing motive force can vary depending upon both the vehicle powertrain configuration and the circumstances of the wheels of the vehicle requiring self-recovery or extraction.

Vehicles can have a variety of powertrain configurations. Conventional gasoline or diesel vehicles generally drive the drive wheels of a vehicle through the use of a gearbox and clutches. The gearbox, along with one or more differential gearboxes, can direct power to specific wheels to varying degrees based on the capabilities of the differential gearboxes. Some embodiments described herein can leverage the use of the differential gearboxes in providing more motive force to one wheel relative to another wheel as detailed further below.

Hybrid electric vehicles that employ both conventional fuel burning engines and electric power can be configured in a variety of ways. The engine can be used to charge a battery that powers one or more electric motors of the vehicle, where the one or more electric motors provide motive power to at least a pair of wheels. In some cases, one or more electric motors can supplement power provided to the wheels of a vehicle by the engine through gearboxes and differential gearboxes.

Purely electric vehicles including battery electric and fuel cell electric vehicles have one or more electric motors driving two or more wheels of the vehicle. In some cases, there is an electric motor for each wheel, while in other cases there may be an electric motor driving a pair of wheels (e.g., the rear wheels) while one or more other electric motors drive a second pair of wheels (e.g., the front wheels). In any case, many electric vehicles are capable of providing power to wheels individually through operation of individual electric motors or through power distribution systems or gearboxes associated with one or more electric motors.

Embodiments described herein employ vehicle motive force to operate in cooperation with a winch to reduce winch load and winch power consumption. While embodiments can be employed on any vehicle, some embodiments described herein are well adapted to use with vehicles having at least partially electric propulsion where wheel speed can more accurately be controlled by a controller of the vehicle.

Embodiments of the present disclosure can include a controller, such as controller 20 or motor control unit 16, that enables vehicle wheel speed control relative to a winched speed of a vehicle as it is being moved by the winch. A vehicle which becomes stuck in a situation may require the aid of a winch to reach a position where the vehicle can drive under its own power via the wheels. Such situations can occur, for example, in muddy conditions, sandy conditions, icy/snowy conditions, or due to terrain irregularities among others.

According to embodiments, a vehicle requiring extraction may have the winch deployed, whereby a person draws out the winch cable from the winch and connects the cable securely to or around an object, such as a tree, boulder, another vehicle, etc. An example of this is illustrated in FIG. 2, with the vehicle 10 including winch 110, where the cable 120 is secured to object 130, e.g., for self-recovery of vehicle 10. The vehicle of some embodiments can be set in a “winch mode”, whereby a user chooses to operate the vehicle in the winch mode. This may be performed via a user interface (e.g., a user interface device 70), such as an infotainment center where selection of the winch mode can be made using a touchscreen display. Optionally, a tactile button or knob can be used to place the vehicle in winch mode.

As discussed herein, ‘winch mode’ refers to a particular operating mode of vehicle 10, e.g., which affects operations of vehicle 10. In this regard, vehicle 10 may be operated in various operating modes (e.g., as controlled by controller 20 and/or other vehicle controllers) that define characteristics of vehicle 10. For example, a ‘sport mode’ may increase the throttle response, stiffen suspension, modify user interfaces, and/or otherwise affect the characteristics of vehicle 10. Likewise, responsive to a user activating ‘winch mode,’ various characteristics and/or operations of vehicle 10 may change. For example, a central display of vehicle 10 may display a ‘winch mode’ specific user interface, e.g., which displays relevant data such as winch draw, vehicle speed, etc. In addition, as discussed in greater detail below, operations of the powertrain of vehicle 10 may be adjusted or otherwise controlled in a manner different to a so-called “normal” operating mode of vehicle 10.

According to some embodiments, upon entering the winch mode, the vehicle may provide user interface controls and display elements that correspond to the winch mode. For example, when a vehicle is being winched, the vehicle may be in a situation in which there are obstacles (e.g., rocks, holes, etc.) such that a camera mode may be provided for display on a user interface. The camera mode may include displays depicting each of the wheels and the terrain the wheel is approaching and/or a display depicting the terrain immediately in front of or behind the vehicle.

The winch mode may optionally display a speed of movement of the vehicle, a direction or heading, a vehicle inclinometer to illustrate a pose angle of the vehicle (fore/aft and/or side/side).

Upon entering the winch mode, the vehicle may control the brakes and/or wheels (e.g., via a controller 20) according to a position of the winch. Optionally, a driver of the vehicle may control the brakes and/or the wheels and speed thereof, though in winch mode, the control may be limited to predefined speeds. For example, a vehicle stuck on an incline may have the brakes applied, if an inclinometer indicates that the vehicle is on a slope, and the winch is drawing the vehicle uphill. In such a case, the vehicle may not release the brakes upon being placed in winch mode as the vehicle may slide down the incline. Instead, the vehicle may await determination, by the controller, of a force pulling the vehicle uphill to release the brakes. Such force determination may occur, for example, using an electric motor that drives one or more wheels detecting a torque in a direction indicating that the vehicle is being pulled uphill.

In the winch mode, if the vehicle is positioned on relatively level surface or where the brakes can be released without the vehicle moving with gravity, then the brakes may be released by a controller to place the vehicle into a neutral position where it can freely roll. The winch may be operated by a winch controller, which may be a wired or wireless controller operated by the vehicle operator or a person outside of the vehicle. Optionally, a winch controller may be integrated into the user interface of the vehicle and operated through the user interface. Upon command by a user, vehicle operator or otherwise, via the winch controller, the winch may begin winding the cable back into the winch.

According to some embodiments described herein, as the winch begins operation of winding the cable back into the winch and pulling the vehicle, the vehicle can determine that winch operation has been initiated. This determination can be made, for example, by the controller 20 described above, where the determination is based on torque at the wheels detected by electric drive motors or based on determined movement of the vehicle as described above. If winch operation is integrated into the vehicle controls, such as via the user interface 70, winch operation initiation can be determined at the moment winch operation is commanded by the controller, without requiring sensor detection.

Responsive to the determination of initiation of operation of the winch, a determination can be made of the speed of movement of the vehicle, such as by the controller 20. This speed determination can be made as described above. Once the speed of movement of the vehicle is established, or as the speed is being established, the vehicle may command one or more of the driven wheels to drive at a speed corresponding to the established speed of movement of the vehicle.

Depending upon the vehicle drive type (internal combustion engine, hybrid, electric) and technology level (e.g., degree of autonomous functionality), the vehicle may have differing capabilities. Commanding vehicle speed through the driven wheels in a vehicle may be limited only to commanding the drive wheels to rotate at a speed corresponding to the speed of movement of the vehicle without feedback from the driven wheels. Vehicles with a higher degree of autonomy and/or those that are fully electric with capability of driving each wheel individually may have additional functionality that is imparted during winch mode. Vehicles with some degree of technological capabilities between the most basic wheel speed control and the most complex control of each individual wheel can employ some, if not all, of the winch mode strategies described in embodiments below.

The effectiveness of each driven wheel can be determined based on the torque exerted at each wheel, as may be identified based on an electrical draw of an electric motor driving a respective wheel. A very low electrical power draw may indicate that the wheel is slipping on the terrain or the wheel is not in contact with the terrain. An electrical power draw below a threshold amount may indicate that the wheel is not contributing to movement of the vehicle. This threshold amount may be, for example, an amount determined by a controller and possibly set by a manufacturer, based on the electrical power draw to rotate a wheel/tire combination when freewheeling or when the tire/wheel are suspended in the air. If a wheel is determined to not be effectively contributing to movement of the vehicle, the wheel may cease to be driven. The wheel may be driven again upon detection of movement of the wheel, such as when the wheel contacts terrain and is rotated indicating the vehicle is advancing forward while the wheel is in contact with the terrain. Reinitiating driving of that wheel can then be used to determine if it aides in movement of the vehicle in the direction the winch is pulling the vehicle.

While a wheel may have little contact with the terrain and may not be beneficial to movement of the vehicle at a point in time, as the vehicle is moved the wheels contributing to movement of the vehicle can change. An electric motor driving a wheel that has a high power draw may be indicative of a wheel that can contribute significantly to movement of the vehicle.

In winch mode, a driver may not need to push the accelerator to cause movement of the wheels at the speed commanded by the winch mode; however, in some embodiments a driver applying pressure to an accelerator pedal may be needed to maintain a human in command to satisfy any relevant legal or regulatory requirements.

The winch mode may be terminated or exited in a number of ways. If a user stops the winch and the winch pull is no longer detected (or if the winch control is integrated with the vehicle user interface), the winch mode may exit. The vehicle under winch mode may stop automatically when the winch stops as there would be no vehicle movement detected that would prompt wheel speed to continue. Optionally, application of the brake pedal may exit winch mode. Further, application of a heavy accelerator pedal input may exit winch mode as a driver may wish to apply substantial torque at the driven wheels to free a stuck vehicle. Winch mode may optionally cease if a person or other object is detected in the path of the vehicle that would be a threat to safety or the vehicle. Winch mode may also cease if the vehicle speed exceeds a predetermined maximum, such as ten miles per hour.

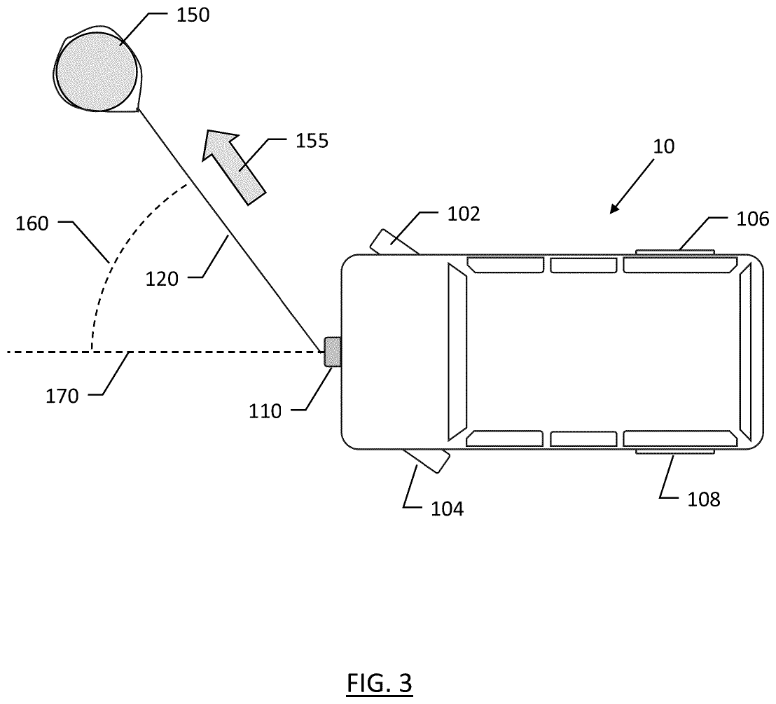

The winch pulling direction is not always ideally aligned with the direction a vehicle is facing, such that embodiments of the winch mode described herein can provide additional functionality to aid in extracting vehicles where the winch cable is at an angle relative to a forward direction of the vehicle. FIG. 3 illustrates such an embodiment where the vehicle 10 includes the winch 110, while the winch cable 120 is arranged at an angle 160 with respect to a forward direction 170 of the vehicle. In such a scenario, the winch cable 120 pulling the vehicle 10 using object 150 pulls the vehicle somewhat laterally relative to the forward direction 170 of the vehicle.

The vehicle may determine this angle 160 based on one or more factors. For example, using a vehicle speed that is LiDAR, camera, or radar based may determine the vehicle is moving laterally as the winch 110 pulls the vehicle 10. Alternatively, vehicle rotation movement may be established, such as by a speed differential between the rear wheels, such as between the right rear wheel 106 and left rear wheel 108, where the left rear wheel may rotate more than the right rear wheel as the front of the vehicle 10 is pulled toward the object. Optionally, the direction the winch is pulling may be identified based on a direction the front wheels are turned by a driver. In the illustrated embodiment of FIG. 3, right front wheel 102 and left front wheel 104 are turned toward the object, such that as the cable 120 is pulled, the front wheels will be more conducive to rotating and providing motive force toward the object out of the stuck position.

In some embodiments, particularly for a vehicle having a higher level of autonomous control, the vehicle may facilitate steering the front wheels toward the object 150. This can be done based on the direction that the cable 120 is pulling the vehicle 10 as described above, or through differences in rotational speed between the left front wheel 104 and right front wheel 102. When the cable 120 is pulling at an angle 160 relative to the forward direction 170 of the vehicle, an outer wheel, such as left front wheel 104, may be instructed via winch mode to operate at a higher speed than the right front wheel 102 as the left front wheel will have a greater distance to travel through a turning of the vehicle 10.

According to some embodiments, the winch mode may not drive the wheels at all times while the winch is pulling the vehicle. The winch mode may require a threshold power draw by the winch before assisting the winch through driving of the wheels of the vehicle. Winch mode may thus be used as a safety mechanism to help reduce power draw by the winch, while enabling the winch to operate normally as long as the threshold level of power draw is not reached.

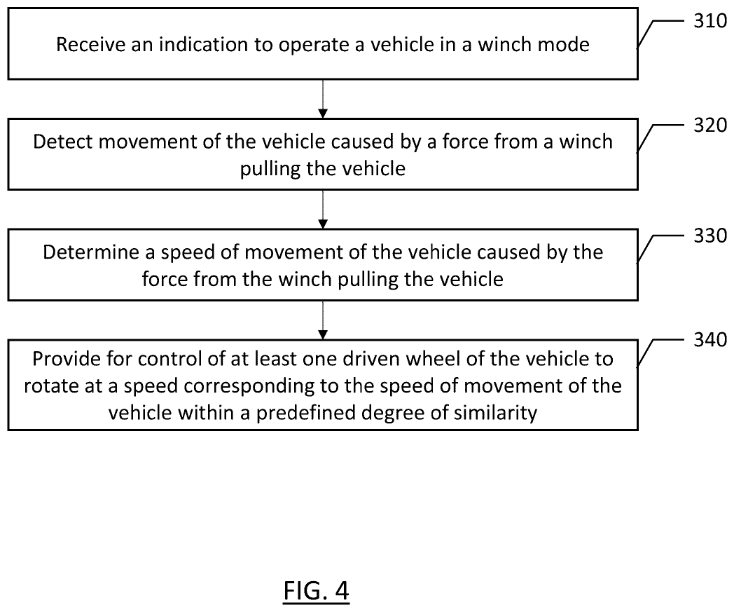

FIG. 4 illustrates a flowchart of a method for operation of a vehicle winch, and more particularly, to controlling a vehicle to provide motive power that reduces a power draw of the vehicle winch. As shown, an indication to operate a vehicle in a winch mode is received at 310. This indication may be, for example, a user selection of the mode via a user interface, such as user interface device 70 of controller 20. Movement of the vehicle caused by a force from a winch pulling the vehicle is detected at 320. This may be detected by sensor(s) 30 or the like. A speed of movement of the vehicle caused by the force from the winch pulling the vehicle is determined at 330. This may also be determined based on sensor(s) 30 of controller 20, for example. At 340, control of at least one driven wheel of the vehicle is provided for to rotate at a speed corresponding to the speed of travel of the vehicle within a predefined degree of similarity. This predefined degree of similarity may include, for example, one or two miles per hour, as the speed at which a vehicle is pulled by a winch is generally relatively low.

As described above, FIG. 4 illustrates a flowchart of methods, computer program products, and systems according to an example embodiment of the disclosure. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory 60 of a controller 20 employing an embodiment of the present disclosure and executed by the processor 50 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks.

These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the method of FIG. 9 above may comprise a processor (e.g., the processor 50) configured to perform some or each of the operations (310-340) described above. The processor may, for example, be configured to perform the operations (310-340) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-340 may comprise, for example, the processor 50 and/or a device or circuit for executing instructions or executing an algorithm for processing information as described above.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the embodiments set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus including at least one processor and at least one non-transitory memory including computer program code instructions, the computer program code instructions configured to, when executed by the at least one processor, cause the apparatus to:
receive an indication to operate a vehicle in a winch mode;
detect movement of the vehicle caused by a force from a winch pulling the vehicle;
determine a speed of movement of the vehicle caused by the force from the winch pulling the vehicle; and
provide for control of at least one driven wheel of the vehicle to rotate at a speed corresponding to the speed of movement of the vehicle within a predefined degree of similarity.

2. The apparatus of claim 1, wherein the speed of movement of the vehicle is determined based at least in part on a speed of rotation of at least one wheel not being driven by a powertrain of the vehicle.

3. The apparatus of claim 1, wherein the speed of movement of the vehicle is determined based at least in part on a speed of rotation of at least one wheel and an outer diameter of a tire associated with the at least one wheel.

4. The apparatus of claim 3, wherein the apparatus is further caused to:
determine a tire pressure of the tire associated with the at least one wheel; and
calculate an effective outer diameter of the tire associated with the at least one wheel based on a size of the tire associated with the at least one wheel and the tire pressure of the tire associated with the at least one wheel.

5. The apparatus of claim 1, wherein the speed of movement of the vehicle is determined based at least in part on an average speed of rotation of at least two wheels of the vehicle.

6. The apparatus of claim 1, wherein causing the apparatus to determine the speed of movement of the vehicle caused by the force from the winch pulling the vehicle comprises causing the apparatus to:
determine the speed of movement of the vehicle based at least in part on detecting movement of the vehicle relative to a stationary object proximate the vehicle.

7. The apparatus of claim 6, wherein causing the apparatus to determine the speed of movement of the vehicle based, at least in part on detecting movement of the vehicle relative to a stationary object proximate the vehicle comprises causing the apparatus to:
determine the speed of movement of the vehicle using a distance-measuring sensor.

8. The apparatus of claim 1, wherein causing the apparatus to provide for control of at least one driven wheel of the vehicle to rotate at a speed corresponding to the speed of movement of the vehicle within a predefined degree of similarity comprises causing the apparatus to:
determine one or more drive wheels that have traction with terrain over which the vehicle is traveling; and
provide power to the one or more drive wheels that have traction with the terrain.

9. The apparatus of claim 8, wherein causing the apparatus to determine one or more drive wheels that have traction with terrain over which the vehicle is traveling comprises causing the apparatus to:
determine a torque force at the one or more drive wheels; and
determine the one or more drive wheels that have traction with the terrain based on the torque force of the one or more drive wheels satisfying a predetermined threshold.

10. The apparatus of claim 8, wherein causing the apparatus to determine the one or more drive wheels that have traction with terrain over which the vehicle is traveling comprises causing the apparatus to:
determine a power draw of at least one electric motor associated with at least one of the one or more drive wheels; and
determine the one or more drive wheels that have traction with the terrain based on the power draw at the at least one electric motor associated with at least one of the one or more drive wheels satisfying a predetermined threshold.

11. A method comprising:
receiving an indication to operate a vehicle in a winch mode;
detecting movement of the vehicle caused by a force from a winch pulling the vehicle;
determining of a speed of movement of the vehicle caused by the force from the winch pulling the vehicle; and
providing for control of at least one driven wheel of the vehicle to rotate at a speed corresponding to the speed of movement of the vehicle within a predefined degree of similarity.

12. The method of claim 11, wherein the speed of movement of the vehicle is determined based at least in part on a speed of rotation of at least one wheel not being driven by a powertrain of the vehicle.

13. The method of claim 11, wherein the speed of movement of the vehicle is determined based at least in part on a speed of rotation of at least one wheel and an outer diameter of a tire associated with the at least one wheel.

14. The method of claim 13, further comprising:
determining a tire pressure of the tire associated with the at least one wheel; and
calculating an effective outer diameter of the tire associated with the at least one wheel based on a size of the tire associated with the at least one wheel and the tire pressure of the tire associated with the at least one wheel.

15. The method of claim 11, wherein the speed of movement of the vehicle is determined based at least in part on an average speed of rotation of at least two wheels of the vehicle.

16. The method of claim 11, wherein determining the speed of movement of the vehicle caused by the force from the winch pulling the vehicle comprises:
determining the speed of movement of the vehicle based at least in part on detecting movement of the vehicle relative to a stationary object proximate the vehicle.

17. The method of claim 11, wherein providing for control of at least one driven wheel of the vehicle to rotate at a speed corresponding to the speed of movement of the vehicle within a predefined degree of similarity comprises:
determining one or more drive wheels that have traction with terrain over which the vehicle is traveling; and
providing power to the one or more drive wheels that have traction with the terrain.

18. The method of claim 17, wherein determining one or more drive wheels that have traction with terrain over which the vehicle is traveling comprises:
determining a torque force at the one or more drive wheels; and
determining the one or more drive wheels that have traction with the terrain based on the torque force of the one or more drive wheels satisfying a predetermined threshold.

19. The method of claim 17, wherein determining one or more drive wheels that have traction with terrain over which the vehicle is traveling comprises:
determining a power draw at an electric motor associated with each of the one or more drive wheels; and
determining the one or more drive wheels that have traction with the terrain based on the power draw at the electric motor associated with each of the one or more drive wheels satisfying a predetermined threshold.

20. A vehicle comprising:
a body;
a winch;
a powertrain; and
a controller configured to:
receive an indication to operate the vehicle in a winch mode;
detect movement of the vehicle caused by the winch pulling the vehicle;
determine a speed of movement of the vehicle caused by the winch pulling the vehicle; and
provide for control of at least one driven wheel of the vehicle to rotate at a speed corresponding to the speed of movement of the vehicle within a predefined degree of similarity.
